(19) United States
(12) Patent Application Publication
(10) Pub. No.: US 2002/0102973 A1
(43) Pub. Date: Aug. 1, 2002

(54) Intelligent roaming method for enabling a mobile station to select a preferred neutral service provider within a communication system

(76) Inventor: William Harry Rosenberg, Austin, TX (US)

Correspondence Address: WILLIAM A. WEBB, Brinks Hofer Gilson & Lione, NBC Tower, Suite 3600, P.O. Box 10395, Chicago, IL, 60610, US

(21) Appl. No.: 09/772,379

(22) Filed: Jan. 29, 2001

(51) Int. Cl. H04Q 7/20

(52) U.S. Cl. 455/432; 455/552; 455/434; 455/525

(57) ABSTRACT

An intelligent roaming method enables a mobile station (68) to select a preferred neutral service provider from a plurality of service providers within a communication system. The mobile station (68) identifies (S.4) a current communication system servicing a geographic area where the mobile station (68) is presently located. The mobile station (68) determines that the current communication system identified is not serviced by a home service provider (S.6) or by a preferred service provider (S.12) having a roaming agreement with the home service provider. Upon not finding home or preferred service, the mobile station (68) determines whether or not it is programmed for full service priority (S. 16.2). If the mobile station (68) is programmed for full service priority, then mobile station (68) selects (S.16.8) the current communication system as the preferred neutral service provider (S.16.7) only when a frequency band of the current communication system corresponds to a first frequency band of frequency bands listed in priority order in a system access list (SAL) (S.16.4) stored in the mobile station (68) to permit the mobile station (68) to obtain full service (i.e., make and receive calls per roaming agreement) from the current communication system. Alternatively, the mobile station (68) selects (S.16.6) the current communication system as a foreign service provider (S.16.5) when the frequency band of the current communication system does not correspond to the first frequency band of frequency bands listed in priority order in the SAL to permit the mobile station (68) to obtain emergency service (i.e., only make “911” calls and not receive calls) from the current communication system. If the mobile station (68) is not programmed for full service priority, then mobile station selects (S.16.3) the current communication system as a neutral service provider to permit the mobile station (68) to obtain limited service (i.e., only make credit card calls and not receive calls) from the current communication system.

### FIELD OF THE INVENTION

The present invention generally relates to telecommunications and, more particularly, relates to an intelligent roaming method for enabling a mobile station to select a preferred neutral service provider within a communication system.

### BACKGROUND OF THE INVENTION

1. Acronyms

The written description provided herein contains acronyms that refer to, for example, various telecommunication services, components and techniques, as well as features relating to the present invention. Although some of these acronyms are known, use of these acronyms is not strictly standardized in the art. For purposes of the written description herein, acronyms will be defined as follows:

Code Division Multiple Access (CDMA)

Complimentary Metal Oxide Semiconductor (CMOS)

Control Channel (CCh)

Digital Control Channel (DCCH)

Electronically Erasable Programmable Read Only Memory (EEPROM)

Federal Communications Commission (FCC)

Group System for Mobile Communications (GSM)

Intelligent Roaming Mode (IR Mode)

Interim Standard (IS)

Liquid Crystal Display (LCD)

Mobile Station (MS)

Mobile Switching Center (MSC)

Mobile Telephone Switching Office (MTSO)

Number Assignment Module (NAM)

Personal Access Communication System (PACS)

Personal Communications Network (PCN)

Personal Communications Services (PCS)

Public Land Mobile Network (PLMN)

Public Switched Telephone Network (PSTN)

Random Access Memory (RAM)

System Access List (SAL)

System Identification Code (SID)

System Operator Code (SOC)

Time Division Multiple Access (TDMA)

2. Background Information

The use of wireless or mobile communication devices has increased greatly in recent years. Cellular telephones have enabled mobile station users to roam over large geographic areas while maintaining immediate access to telephony services. Mobile stations include portable units, units installed in vehicles and fixed subscriber stations. Mobile stations comprising cellular telephones or wireless handsets are operable in cooperation with cellular or Personal Communications Services (PCS) communications systems. Cellular communication systems typically provide service to a geographic area by dividing the area into many smaller areas or cells. Each cell is serviced by a radio transceiver (i.e., a transmitter-receiver base station or cell site). The cell sites or base stations may be connected to Mobile Telephone Switching Offices (MTSOs) or Mobile Switching Centers (MSCS) through landlines or other communication links, and the MTSOs may, in turn, be connected via landlines to the Public Switched Telephone Network (PSTN).

FIG. 1 illustrates the basic components of a conventional cellular network. As shown in FIG. 1, a mobile station 38 may place or receive calls by communicating with a cell site 30 or a cell site 40, depending upon the geographic location of the mobile station and the cell coverage area that is provided by each cell site (i.e., cell coverage area 35 of cell site 30 or cell coverage area 45 of cell site 40). For purposes of illustration, mobile station 38 is depicted in FIG. 1 as being able to communicate with either cell site 30 or cell site 40, even though the mobile station is not illustrated as being located within cell coverage area 35 or cell coverage area 45. Under normal operating conditions, the extent to which mobile station 38 will be able to communicate with cell site 30 or cell site 40 will depend on the geographic location of the mobile station and the size of the cell coverage area of each cell site. Further, although only two cell sites are depicted in FIG. 1, the entire cellular network may include, for example, more than two cell sites. In addition, more than one cell site may be connected to each MTSO.

Mobile station 38 may include a conventional cellular telephone unit with a transceiver and antenna (not shown) to communicate by, for example, radio waves with cell sites 30 and 40. Various air-interface technologies may be implemented to facilitate communication between the mobile station and the cell sites. Cell sites 30 and 40 may both include a radio transceiver (not shown) and be connected by landlines 16 or other communication links to MTSOs 24 and 28. The PSTN 12 is also connected to each MTSO 24 and 28 by landline 16 or other communication links.

The MTSOs 24 and 28 may be conventional digital telephone exchanges that control the switching between PSTN 12 and the cell sites 30 and 40 to provide wireline-to-mobile, mobile-to-wireline and mobile-to-mobile call connectivity. The MTSOs 24 and 28 may also (i) process mobile station status data received from the cell site controllers; (ii) handle and switch calls between cells; (iii) process diagnostic information; and (iv) compile billing information. The transceiver (not shown) of each cell site 30 and 40 provides communications, such as voice and data, with mobile station 38 while it is present in its geographic domain. The MTSOs 24 and 28 may track and switch mobile station 38 from cell site to cell site, as the mobile station passes through various coverage areas. When mobile station 38 passes from one cell to another cell, the MTSO of the corresponding cell may perform a “hand-off” that allows the mobile station to be continuously serviced.

In the current North American cellular system, any given area may be serviced by multiple competing service providers of cellular airtime communication services. By Federal Communications Commission (FCC) regulations, the competing service providers are assigned different groups of frequencies through which services are provided. A frequency set typically includes control channels and voice channels. The control channels are used for preliminary communications between a mobile station and a cell site for setting up a call, after which a voice channel is assigned for the mobile station's use on that call. The assigned frequency sets are generally referred to as “A band frequencies” and “B band frequencies” and may also include several PCS frequency bands. While each frequency set for a given cellular service area is assigned to only one service provider, in different service areas the same frequency set may be assigned to different service providers or companies.

Depending upon which service provider is subscribed to by the user of the mobile station, the home frequency set of the user may correspond to one or more frequency bands. Whenever the mobile station places a call, the mobile station will ordinarily attempt to use the home frequency set to establish the call. If a call is handled outside of the user's home network area, then the unit is said to be “roaming” and service will be attempted through a frequency set of a non-home service provider. Typically, the user's home service provider will have a roaming agreement or a reciprocal billing arrangement between the home service provider and the non-home service provider to permit service to be extended to the user's mobile station when it is roaming in the non-home service provider's service area without requiring the user to preregister or use a credit card to place and receive calls.

The mobile station may include a memory device, such as a number assignment module (NAM), in which an assigned phone number and a system identification (SID) code is stored to uniquely identify the home service provider for the mobile station. The memory device may also store a system operator code (SOC) to uniquely identify dispersed geographic service areas serviced by the same system operator. In the North American cellular system, each cellular market or provider is assigned a distinct, fifteen bit SID code. In Europe, the Global System for Mobile Communications (GSM) standard (see, for example, Recommendation GSM 02.11, Service Accessibility, European Telecommunications Standards Institute, 1992) defines a process for network selection based on the mobile station reading the GSM equivalent of the SID, called the Public Land Mobile Network (PLMN) identity. The SID or equivalent system identification number is broadcast by each service provider or cellular provider and is used by the mobile station to determine whether or not the mobile station is operating in its home network or if it is operating in a roaming condition. The mobile station makes this determination by reading the SID and/or SOC that is broadcast in the cellular market in which it is located, and comparing it to the home SID and/or SOC stored in the NAM of the cellular phone unit. If the SIDs or SOCs do not match, then the mobile station is roaming, and the mobile station must attempt to gain service through a non-home service provider. Due to the imposition of a fixed surcharge or higher per unit rate, the airtime charges when the mobile station is roaming are customarily higher than when the mobile station is operating within its home network.

Operation under a roaming condition is often under the control of the user of the mobile station. The user can select whether the mobile station will operate in a Home System Only, A Band Only, B Band Only, A Band Preferred, B Band Preferred, or one of the PCS Bands. The user typically controls the system preference and mode operation through menu choice or selection. This current method of roaming control is conventionally known as “Preferred System Selection”. In the most common roaming situation, the mobile station remains on the same band as the home cellular network. Thus, if the mobile station is homed to a cellular network with an odd numbered SID (which is normally assigned to an A band cellular service provider), then the mobile station will obtain service from the A band cellular service provider when roaming.

Occasionally, the home service provider will program a mobile station with negative SIDs. Negative SIDs correspond to SIDs on which the mobile station should not obtain service. Negative SIDs may be used, for example, if roaming agreements are not in place between different cellular service providers. An example of a mobile station that utilizes negative SIDs is disclosed in U.S. Pat. No. 4,916,728—Blair. As an alternative to negative SIDs, some mobile stations are programmed with positive or preferred SIDs. Positive or preferred SIDs are SIDs on which the mobile station should attempt to obtain service when selecting a cellular carrier frequency. An example of a mobile station that utilizes preferred SIDs is disclosed in U.S. Pat. No. 5,442,806—Barber et al. The use of preferred SIDs facilitate the selection of a preferred service provider when the mobile station is roaming.

Presently, there is a need in the cellular and mobile network industries to provide some form of “intelligent” or “automatic” roaming in which the mobile station obtains service on the non-home cellular network with which the home cellular service provider has the best roaming agreement (or the cellular service provider's own network in the roaming area, if it is not in the same band as the home system). Examples of “intelligent” or “automatic” roaming methods in which the mobile station obtains service on the non-home cellular network are found in U.S. Pat. No. 6,148,198—Anderson, et al., U.S. Pat. No. 5,950,130—Coursey, U.S. Pat. No. 5,884,182—Hoover, U.S. Pat. No. 5,790,952—Seazholtz, et al., and U.S. Pat. No. 6,148,197—Bridges et al. There are three factors that have primarily led to this need. First, large cellular service providers rarely operate in the same band in all markets. Secondly, cellular service providers have chosen to implement three distinct technologies at 800 MHz (i.e., Analog Only, Time Division Multiple Access (TDMA), and Code Division Multiple Access (CDMA)), and the mobile station may have to change bands to obtain service on the preferred technology. Third, with the advent and development of Personal Communications Services (PCS), there is an increasing desire for roaming to, for example, 1900 MHz PCS systems.

As will be appreciated by those skilled in the art, PCS covers a broad range of individualized telecommunication services that let users communicate irrespective of where they are located. With PCS, personalized numbers are assigned to individuals rather than to the mobile stations, and call completion is performed regardless of the location of the user. PCS may be implemented through conventional macrocellular techniques or through Personal Communications Networks (PCN) that utilize light, inexpensive handheld handsets and communicate via low-power antennas that are intended to operate in a similar fashion to that of large scale cellular telephone networks, but operate within small geographic or microcellular areas. It is anticipated that PCNs will operate within the same frequency band in most countries (e.g., 1850-1990 Mhz), while cellular systems will operate in different frequency bands in various countries.

In the marketplace today, there is also a need to provide intelligent roaming capabilities when the mobile station cannot find a preferred network service provider. In conventional systems, the mobile station includes a database or a system access list (SAL) that stores system information, such as the negative or preferred SIDs, negative or preferred SOCs and the available frequency bands. The mobile station also includes a software algorithm that scans the network service provider information in the database according to predetermined criterion, such as usage charges or availability of digital features, to determine the preferred carrier for a present service locality. When the mobile station scans the information in the database, any network service provider that does not match the network service provider information in the database is classified as a neutral network service provider. When the mobile station cannot find a preferred network service provider by scanning the database, the mobile station uses a neutral network service provider. If the mobile station determines that several neutral network service providers are available, then the mobile station typically chooses the neutral network service provider based on the order that mobile station scans the frequency bands. Typically, only one frequency band has roaming and call delivery enabled. However, if the home network service provider does not have a roaming agreement with the neutral network service provider having the selected frequency band, then the mobile station will not be able to receive calls and will need to use a credit card to make calls. Unfortunately, the users of the mobile station are not notified whether they have full service, wherein they can receive and make calls, or limited service, wherein they can't receive calls and can make calls only with a credit card. Hence, some users are dissatisfied to find out that they were not able to receive calls and that the calls that they did make were at a much higher charge. It would be desirable to provide intelligent roaming capabilities for a mobile station to find an appropriate neutral network service provider when the mobile station scans for a non-home network service provider. Prior systems do not provide, for example, sufficient intelligence in the mobile station to efficiently direct the mobile station to the particular frequency band or frequency bands where the mobile station may obtain service from a preferred neutral network service provider when it is roaming. Accordingly, there is a need for an intelligent roaming method for enabling a mobile station to select a preferred neutral service provider within a communication system.

### BRIEF DESCRIPTION OF THE DRAWINGS

The drawings provide non-limiting examples of a preferred embodiment of the present invention that is described in the following detailed description section wherein like reference numerals represent similar elements throughout the drawings.

FIG. 1 illustrates a block diagram of a conventional cellular communication system in accordance with the prior art.

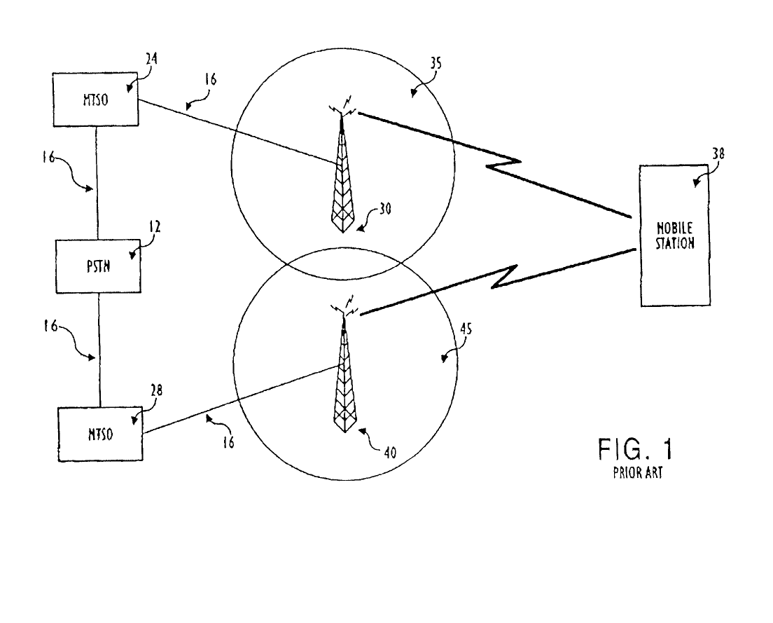

FIG. 2A illustrates a block diagram of a communication system, preferably cellular or PCS, including a communication network and a mobile station, in accordance with a preferred embodiment of the present invention.

FIG. 2B illustrates a front elevation view of a mobile station, preferably implemented as a cellular telephone unit, shown in FIG. 2A, in accordance with a preferred embodiment of the present invention.

FIG. 2C illustrates a block diagram of the mobile station, shown in FIG. 2B, in accordance with a preferred embodiment of the present invention.

FIG. 3 illustrates a flowchart describing an intelligent roaming method for enabling the mobile station, shown in FIGS. 2B and 2C, to select a service provider within the communication system, shown in FIG. 2A, in accordance with a preferred embodiment of the present invention.

FIG. 4 illustrates a flowchart describing an intelligent roaming method, detailing step S. 16 of FIG. 3, for enabling the mobile station, shown in FIGS. 2B and 2C, to select a preferred neutral service provider within the communication system, shown in FIG. 2A, in accordance with a preferred embodiment of the present invention.

### DETAILED DESCRIPTION OF THE PREFERRED EMBODIMENT

The present invention relates to an intelligent roaming method for enabling a mobile station to select a preferred neutral service provider within a communication system. The present invention permits a mobile station to obtain service on a preferred cellular or PCS system, when there are multiple bands and multiple air-interface technologies available. In the preferred embodiment of the present invention, a System Access List (SAL) is stored within a memory or other storage device of the mobile station. When the mobile station is roaming, the SAL may be accessed to indicate the band or bands where the mobile station may find a service provider. The SAL may also include information to indicate the air-interface technology supported on each of the preferred bands, to assist the mobile station in finding a system of a given technology type.

According to an aspect of the present invention, the mobile station identifies a current communication system servicing a geographic area where the mobile station is presently located. The mobile station determines that the current communication system identified is not serviced by a home service provider or by a preferred service provider having a roaming agreement with the home service provider. Upon not finding home or preferred service, the mobile station determines whether or not it is programmed for full service priority. If the mobile station is programmed for full service priority, then mobile station selects the current communication system as the preferred neutral service provider only when a frequency band of the current communication system corresponds to a first frequency band of frequency bands listed in priority order in the SAL to permit the mobile station to obtain full service (i.e., make and receive calls per roaming agreement) from the current communication system. Alternatively, the mobile station selects the current communication system as a foreign service provider when the frequency band of the current communication system does not correspond to the first frequency band of frequency bands listed in priority order in the SAL to permit the mobile station to obtain emergency service (i.e., only make “911” calls and not receive calls) from the current communication system. However, if the mobile station is not programmed for full service priority, then mobile station selects the current communication system as a neutral service provider to permit the mobile station to obtain limited service (i.e., only make credit card calls and not receive calls) from the communication system. These and other features and advantages of the preferred embodiment of the present invention are described in greater detail with reference to the accompanying drawings.

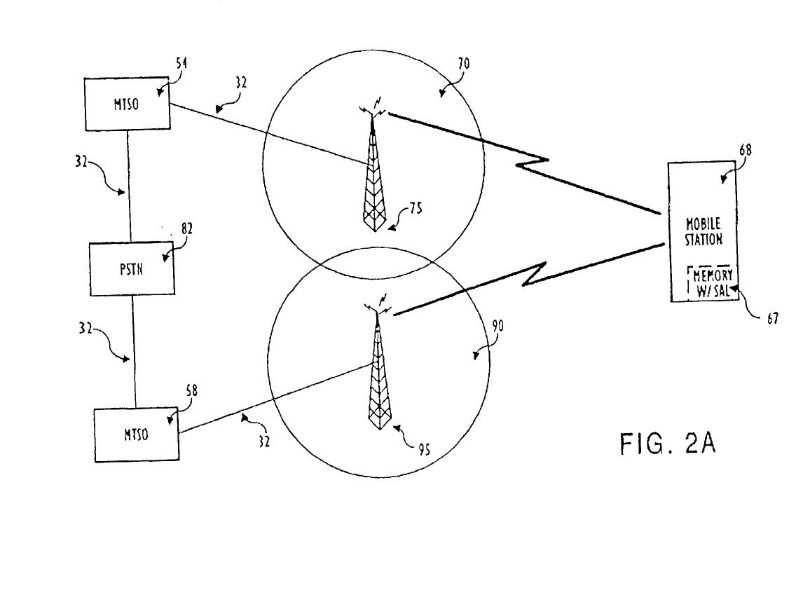

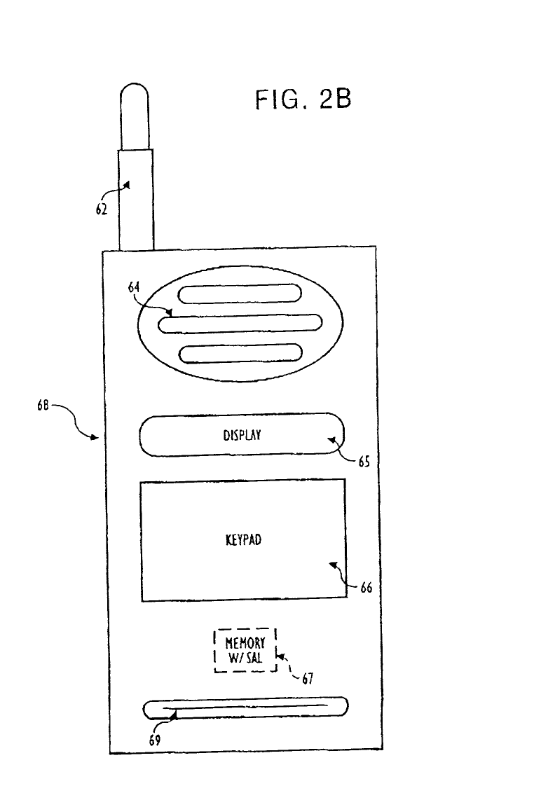

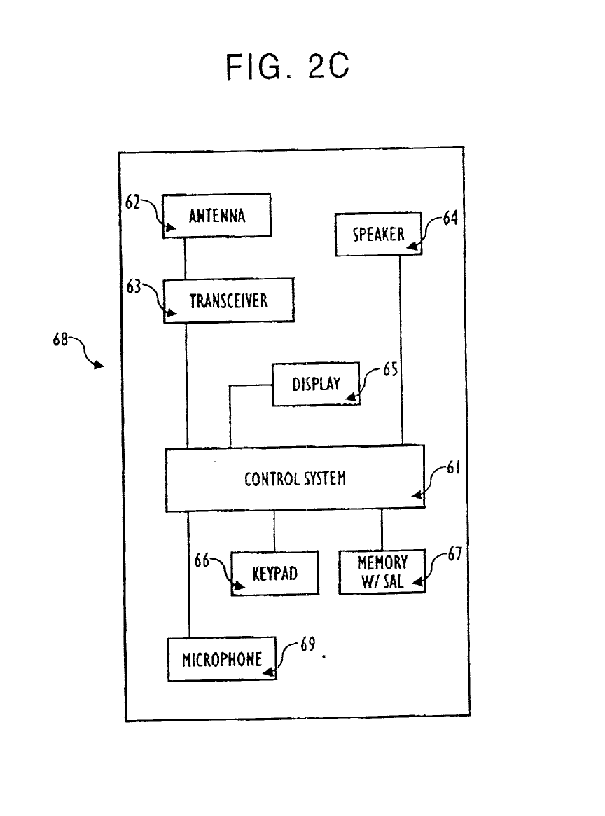

FIGS. 2A-2C illustrate a communication system including a mobile station for implementing the intelligent roaming capabilities of the preferred embodiment of the present invention. In FIGS. 2A-2C, a mobile station-based approach is provided for implementing the intelligent roaming capabilities of the invention. According to the mobile-station approach of the invention, each mobile station is programmed with intelligent roaming capabilities so that it can determine which system it should obtain service on prior to registration. As will be appreciated from the following description, the mobile station-based approach for providing intelligent roaming capabilities has several advantages, including the ability to integrate into conventional cellular or PCS network environments without requiring modification to the main network components, and without requiring any changes to current network interface standards (e.g., IS-41) or air interface standards (e.g., IS-136, IS-91A, IS-95). According to the preferred embodiment of the present invention, the mobile station-based approach also accommodates an intelligent roaming method for enabling the mobile station to select a preferred neutral service provider within the communication system only when the preferred neutral service provider corresponds to a first frequency band of the available frequency bands stored in the mobile station.

FIG. 2A illustrates a block diagram of the communication system, preferably cellular or PCS, including the communication network and the mobile station, in accordance with a preferred embodiment of the present invention Although the present invention is described with reference to a cellular network environment, the present invention may also be applied to a PCS or PCN network environment, in which lower powered cell sites and smaller cell areas are utilized. In FIG. 2A, a mobile station 68 is provided with a memory device 67 for storing a System Access List (SAL). According to a preferred embodiment of the present invention, the SAL may be preprogrammed into the mobile station prior to activation of the unit and/or may be reprogrammed and updated by using, for example, a physical interface (such as a computer interface) or over-the-air programming techniques. The SAL may indicate the frequency band or frequency bands where a mobile station may find a preferred system when roaming. That is, the SAL may include information on blocks of channels to scan in the preferred bands, so that the mobile station may quickly obtain service on the preferred system in any area where there is cellular coverage. The SAL may also include information for the mobile station to use in determining whether to display a roam icon, and what alphanumeric system name to display when operating on a given system. Air-interface technology information may also be provided in the SAL to indicate which air interface technologies are supported on each of the preferred bands and to facilitate the mobile station in finding a system of a given technology type.

The mobile station 68 may comprise portable phone units, units installed in vehicles and fixed subscriber units. By way of non-limiting example, the mobile station 68 may be implemented as a cellular telephone unit with a transceiver and antenna (see, for example, FIGS. 2B and 2C) to communicate by, for example, radio waves with one or more cell sites. In FIG. 2A, cell sites 75 and 95 are illustrated. The mobile station 68 may place or receive calls by communicating with cell site 75 or cell site 95, depending upon the location of the mobile station and the cell coverage area that is provided by each cell site. That is, when mobile station 68 is located within cell coverage area 70 it may communicate with cell site 75, and when it is located within cell coverage area 90 it may communicate with cell site 95. As will be appreciated by those skilled in the art, the actual cell coverage area for a cell site will depend upon various factors, including the power of the transceiver of the cell site, the placement and location of the cell site, and the topography of the locality and surrounding areas where the cell site is located. Further, although only two cell sites are depicted in FIG. 2A, the cellular network may of course include more than two cell sites. Moreover, it should be noted that the various components of the cellular network depicted in FIG. 2A are provided for the purpose of illustration only, and that other type of network arrangements may of course be provided to implement the features of the invention. In addition, more that one cell site may of course be served by each MTSO.

Various air-interface technologies (e.g., TDMA, CDMA, PACS, and PCS-1900 MHz) may be utilized to facilitate communication between the mobile station and the cell sites. Each of the cell sites 75 and 95 may include, for example, a radio transceiver (not shown) and be connected by landlines 32 or other communication links to Mobile Switching Centers (MSCs) or Mobile Telephone Switching Offices (MTSOS) 54 and 58. Landlines 32 may also be utilized to connect the MTSOs 54 and 58 to Public Switch Telephone Network (PSTN) 82.

The MTSOs 54 and 58 may be conventional digital telephone exchanges that control the switching between PSTN 82 and the cell sites 75 and 95 to provide wireline-to-mobile, mobile-to-wireline and mobile-to-mobile call connectivity. The MTSOs may provide various functions, including (i) processing mobile station status data received from the cell site controllers, (ii) handling and switching calls, (iii) processing diagnostic information, and (iv) compiling billing information. The transceiver (not shown) of each cell site 75 and 95 may provide communication services, such as voice and data communication, with mobile station 68 while it is present in its cell coverage area. Tracking and switching of the mobile station from cell site to cell site may be handled by the MTSOs, as the mobile station passes through various cell coverage areas. When, for example, mobile station 68 passes from one cell to another cell, the MTSO of the corresponding cell may perform a “hand-off” that allows the mobile station to be continuously serviced.

As shown in FIG. 2B, the mobile station 68 may be implemented as a cellular telephone unit that comprises an antenna 62, a speaker 64, a microphone 69, a display 65, and a keypad 66 for entering alphanumeric information. The cellular telephone unit of mobile station 68 may be constructed in a similar fashion to that of a conventional cellular telephone, with the exception of unique programming and memory configurations and contents for implementing the intelligent roaming aspects of the present invention. Further, the memory 67 of the mobile station 68 may be configured to handle a greater capacity than that of a conventional cellular telephone, in order to accommodate the SAL and other operational information of the present invention.

Accordingly, mobile station 68 may include a speaker 64 that comprises a conventional speaker for converting electrical audio signals received by antenna 62 into acoustic audio signals, and a microphone 69 that comprises a conventional microphone for converting voice utterances of a user from acoustic audio signals into electrical audio signals for transmission by antenna 62. In addition, display 65 and keypad 66 may be implemented by conventional display and keypad devices for displaying and permitting entry of alphanumeric and other information. By way of a non-limiting example, display 65 may comprise dedicated status lights and/or a liquid crystal display (LCD) to indicate the status of the cellular telephone unit (e.g., “No Service”, “Roam”, etc.). Further, keypad 66 may comprise menu selection buttons and/or a conventional twelve button, alphanumeric keypad for initiating and receiving calls, and programming or selecting operating conditions for the mobile station.

Memory 67 of the mobile station 68 may store the SAL and other operational information of the present invention. The memory 67 is generally referred to as a computer-readable data storage medium. Memory 67 may comprise a read-write memory device that has an independent power supply or whose contents will not be effected by power downs of ordinary duration. By way of non-limiting examples, memory 67 may be implemented by a programmable Electronically Erasable Programmable Read Only Memory (EEPROM), a Complimentary Metal Oxide Semiconductor (CMOS) memory chip, or a conventional Random Access Memory (RAM) with an independent power supply.

FIG. 2C illustrates a block diagram of the mobile station, shown in FIG. 2B, in accordance with a preferred embodiment of the present invention. As discussed above, the cellular telephone unit of the mobile station 68 may comprise an antenna 62, a speaker 64, a display 65, a keypad 66, and a microphone 69. The antenna 62 may be connected to a transceiver 63, which in turn is connected to a control system 61. Control system 61 may be implemented as a microprocessor-based, control system and may be programmed to carry out the intelligent roaming features and logic of the present invention. The programming of control system 61 may be carried out by any suitable combination or use of software, hardware and/or firmware. Control system 61 may control the various components of the mobile station 68 to permit a user to send and receive calls and program the mobile station. In addition, control system 61 may have access to memory 67, in which the SAL and other programming information is stored, for directing operation of the mobile station. A more detailed description of the various processes and functions of the intelligent roaming features of the present invention, as well as the logic steps associated with the intelligent roaming method, is provided below with reference to the accompanying drawings.

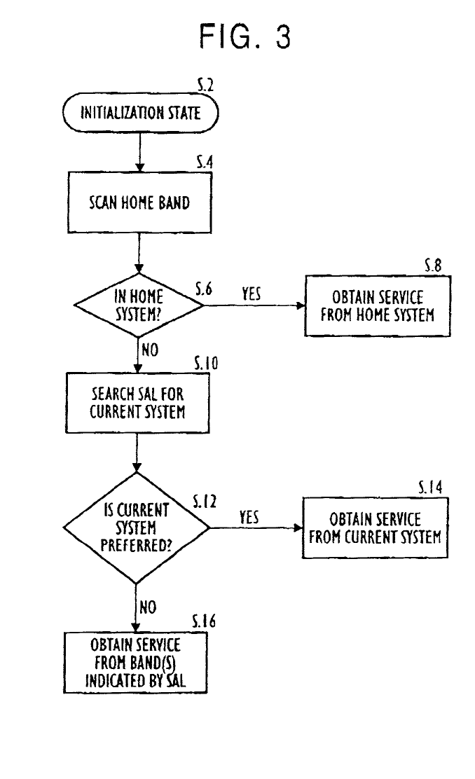

FIG. 3 illustrates a flowchart describing an intelligent roaming method for enabling the mobile station, shown in FIGS. 2B and 2C, to select a service provider within the communication system, shown in FIG. 2A, in accordance with a preferred embodiment of the present invention. The intelligent roaming method of FIG. 3 operates according to the standard TIA EIA 136-123 A section 4.1.6, wherein “136” describes the TDMA cellular standard, “123” describes the digital control channel (DCCh) layer 3, “section 4.1” describes the DCCh scanning and locking, and “section 4.1.6” describes an intelligent roaming process. The various processes and operations illustrated in FIG. 3 may be carried out by control system 61 of the mobile station 68 through the use of programmed logic or firmware. The intelligent roaming process of the present invention permits each mobile station to automatically obtain service on the most appropriate and/or preferred cellular system. Although the description below is made with reference to a cellular network environment, the various processes and operation may also be applied to PCS or PCN network systems.

In FIG. 3, a mobile station enters an initialization state at step S.2, when the mobile station is powered ON, changes systems, is in a “No Service” condition, or when an Intelligent Roaming (IR) mode has been selected by the user. After the mobile station has been initialized, the mobile station first scans for its home band (i.e., the set of frequencies corresponding to its home network system) at step S.4 to locate a control channel. The set of frequencies corresponding to the home band of the mobile station may be programmed into the mobile station's memory (e.g., memory 67) by the home system service provider. The mobile station may scan for its home band continuously or periodically depending on various considerations that are well known in the art.

At step S.6, the mobile station determines whether it is in its home system. Whether or not the mobile station is located in its home system may be determined by analyzing the SID or equivalent system identification number of the cellular service provider for the area in which the mobile station is located. By comparing the SID received on the control channel with the home SID of the home service provider, the mobile station 68 may determine whether it is located in its home system. As described above, the home SID may be stored in the NAM of the mobile station, or may be stored in another appropriate memory or storage device of the mobile station. For example, the home SID may be stored separately from the SAL of the mobile station, or may be stored in memory 67 as part of the SAL.

If the mobile station determines that it is located in its home system, then at step S.8, the mobile station will stay on that band and obtain service from the home service network provider. However, if the mobile station determines that it is not in its home system, then at step S. 10 the SAL stored in the mobile station will be accessed and searched to determine if a preferred network provider exists for the current communication system. In accordance with an aspect of the present invention, the SAL stored in the mobile station may comprise a table of entries including the SIDs and corresponding frequency band(s) of all of the preferred service providers. The preferred service providers may correspond to cellular service providers that the mobile station's home system has a reciprocal agreement or billing arrangement with to provide service when the mobile station is roaming. Entries in the SAL may be provided for the SIDs associated with each region within which one or more preferred service providers exist (e.g., the SAL may include entries for one or more of the SIDs assigned in the North American cellular system). If more than one preferred or target system exists for a given region, then the preferred systems in an SAL entry may be listed in order of preference and/or the air interface technology may be provided for each preferred system so that the mobile station may select the most appropriate system for that region. The information fields or elements for the SAL and SAL entries are well known to those skilled in the art.

If, for example, the SAL is stored in the memory 67 of the mobile station 68, then memory 67 should be provided with sufficient storage capacity in order to store all of the necessary operational information, including the SIDs and corresponding frequency bands of all the preferred or target systems that exist. As a result, the memory 67 provided in the mobile station 68 of the present invention may have to be implemented with a memory capacity that is larger than that of, for example, conventional mobile stations. However, the capacity of the memory may be limited by restricting the SAL to contain entries only for SIDs on the home and secondary bands. By comparing the broadcasted SID of the current communication system with the SIDs of the entries in the SAL, the mobile station can determine, at step S.12, whether the current communication system is a preferred system (i.e., whether the current communication system corresponds to a preferred service provider that has a service agreement or billing arrangement with the user's home network service provider).

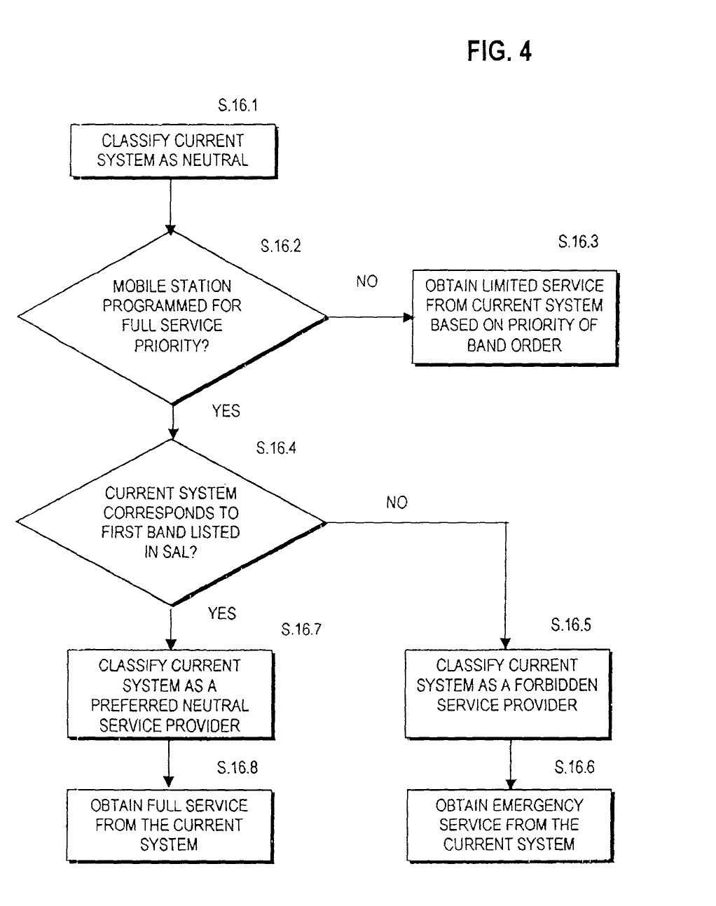

If the current communication system corresponds to a preferred system for the area in which the mobile station is located, then at step S.14 the mobile station will stay on that band and obtain service from the preferred system. If, however, the current communication system is not the preferred system for the given area, the SAL will indicate the band or bands where the mobile station may find a preferred system, and the mobile station will obtain service from the preferred system on indicated band(s) at step S.16. Thus, the mobile station may obtain service by switching to the indicated band of the preferred system without having to randomly scan bands until a preferred system is located. Further details of step S.16 are described with reference to FIG. 4.

Additional features may be incorporated into the embodiment of FIG. 3. For example, if a control channel cannot be located on the home band at step S.4, an indication may be displayed to the mobile station user to indicate that “No Service” is available. In addition, in accordance with another aspect of the invention, when no control channels are found on the home band at step S.4, the mobile station may scan a defined secondary band to locate a control channel. The secondary band may be defined and set up as a band in which the mobile station is guaranteed of finding a control channel (e.g., either the A band or B band at 800 MHz). The frequencies of the secondary band that should be scanned by the mobile station may be stored in the memory of the mobile station. If a control channel is found on the secondary band, then logic could proceed directly from step S.4 to step S.10 to determine if the current communication system is a preferred system. Thereafter, service may be obtained in accordance with steps S. 12 and S. 16 in FIG. 3.

The SAL that is stored in the mobile station may include various information for each stored SID entry. This information may include the set of frequencies where a preferred system may be found when the mobile station is roaming, as well as the air interface technology that is supported on each of the preferred bands to assist the mobile station in finding a system of a given technology type. The SAL may also provide information that directs the mobile station to search particular channels (e.g., RF channels) in the preferred band for a control channel. As a result, the mobile station may quickly obtain service on a preferred system in any area where there is cellular or PCS coverage. The method in FIG. 3 reduces channel scanning and acquisition time by utilizing the SAL that directs the mobile station to the exact band(s) where the preferred system may be found when outside of the home network area. Further, the method of FIG. 3 is mobile station-based to permit integration into conventional network architectures without requiring any modification to current network or air-interface standards.

FIG. 4 illustrates a flowchart describing an intelligent roaming method, detailing step S. 16 of FIG. 3, for enabling the mobile station, shown in FIGS. 2B and 2C, to select a preferred neutral service provider within the communication system, shown in FIG. 2A, in accordance with a preferred embodiment of the present invention. Continuing from step S.12 in FIG. 3, when a determination is made that the current communication system is not preferred, the current communication system is classified as neutral at step S.16.1. A neutral system is a system that does not match any entry in the SAL 67. Generally, a mobile station that cannot find a higher priority system, will choose a neutral system to obtain service. Neutral systems are typically in the 800 MHz cellular band.

Next, at step S. 16.2, a determination is made whether the mobile station was programmed for full service priority. Just as the mobile station is programmed with the SAL, the mobile station is preferably programmed or configured to give priority to full service for the mobile station by the home service provider. This programmable feature is preferably enabled or disabled by the home service provider based on considerations such as user expectations of service, system coverage area, and the like. If a determination that the mobile station was not programmed for fill service priority, then the mobile station obtains limited service from the current communication system based on a priority from first to last of the bands stored in the SAL, at step S.16.3. At step S.16.3, if several current communication systems are identified as being available by the mobile station, then the neutral system with the highest priority order in the SAL list will be chosen to obtain service. Limited service prohibits the mobile station from receiving incoming calls and permits the mobile station to make outgoing calls using a credit card. In this case, the home system provider does not have a roaming agreement with the current communication system provider. However, if a determination that the mobile station was programmed for full service priority, then process continues to step S. 16.4.

At step S.16.4, a determination is made whether the band of the current communication system corresponds to a predetermined frequency band listed in the SAL. In the preferred embodiment of the present invention, the predetermined frequency band is a first frequency band of frequency bands listed in priority order in the SAL. Typically, the first frequency band corresponds to the frequency band serviced by the home service provider. If a determination is made that the band of the current communication system does not correspond to the first band listed in the SAL, then the mobile station classifies the current communication system as a forbidden service provider at step S. 16.5 and the mobile station is permitted to obtain only emergency service from the current communication system at step S.16.6. A forbidden service provider is a service provider that a mobile station can obtain emergency service from. A user accesses the emergency service by dialing “911” on the keypad of the mobile station. In this case, the home system provider also does not have a roaming agreement with the current communication system provider, but emergency service is permitted to promote and enhance public safety.

However, if a determination is made that the band of the current communication system does correspond to the first band listed in the SAL, then the mobile station classifies the current communication system as a preferred neutral service provider at step S.16.7 and the mobile station obtains full service from the current communication system at step S.16.8. A mobile station having full service is permitted to receive incoming calls and to make outgoing calls without the use of a credit card. In this case, the home system provider may have a roaming agreement with the current communication system provider.

Therefore, the method of FIG. 4 permits the system service provider with a choice, at step S.16.2, of whether to obtain limited service from the current communication system or to possibly obtain full service from the current communication system. Some users may prefer to for their mobile station to locate a neutral system even though the service is limited. This case may be summarized as expensive, limited service, since the credit card call is expensive and the mobile station is limited to only making outgoing calls. Other users, however, may prefer for their mobile station to locate a neutral system that will give them full service when the signal strength is strong enough and when the signal strength is not strong enough to only have emergency service. This case may be summarized as a inexpensive, full service, since the calls are inexpensive because of a roaming agreement and the mobile station has full service to make or receive calls. This choice may be made by the home service provider programming the mobile station at their own discretion, may be made at the request of the user of the mobile station for the home service provider to program their mobile station, or may even be made by the user of the mobile station programming the mobile station by themselves. No matter how the choice is made, the user's expectations of how their mobile station will work in a roaming situation will be aligned with the intelligent roaming operation of their mobile station.

While the present invention has been described herein with reference to various illustrative embodiments thereof, the present invention is not intended to be limited to these specific embodiments. Those skilled in the art will recognize that variations and modifications can be made to the present invention without departing from the spirit and scope of the present invention as set forth in the appended claims.

What is claimed is:

1. An intelligent roaming method for enabling a mobile station to select a preferred neutral service provider from a plurality of service providers within a communication system, the method comprising the steps of:
identifying a current communication system servicing a geographic area where the mobile station is presently located;
determining that the current communication system is not serviced by a home service provider responsive to the step of identifying the current communication system;
determining that the current communication system is not serviced by a preferred service provider responsive to the step of identifying the current communication system;
determining that a frequency band of the current communication system corresponds to a predetermined frequency band of frequency bands listed in a system access list (SAL) stored in the mobile station responsive to the steps of determining that the current communication system is not serviced by the home service provider and the preferred service provider; and
selecting the current communication system as the preferred neutral service provider only when the frequency band of the current communication system corresponds to the predetermined frequency band of frequency bands listed in the SAL to permit the mobile station to obtain full service from the current communication system.

2. The intelligent roaming method according to claim 1 wherein the predetermined frequency band further comprises a first frequency band of the frequency bands listed in priority order in the SAL.

3. The intelligent roaming method according to claim 1 further comprising the steps of:
determining that a frequency band of the current communication system does not correspond to the predetermined frequency band of frequency bands listed in the SAL stored in the mobile station responsive to the steps of determining that the current communication system is not serviced by the home service provider and the preferred service provider; and
selecting the current communication system as a foreign service provider responsive to the step of determining that the frequency band of the current communication system does not correspond to the predetermined frequency band of frequency bands listed in the SAL to permit the mobile station to obtain emergency service from the current communication system.

4. The intelligent roaming method according to claim 1 further comprising the steps of:
determining that the mobile station is programmed for full service priority responsive to the steps of determining that the current communication system is not serviced by the home service provider and the preferred service provider,
wherein the mobile station selects the current communication system as the preferred neutral service provider only when the frequency band of the current communication system corresponds to the predetermined frequency band of frequency bands listed in the SAL responsive to the step of determining that the mobile station is programmed for full service priority.

5. The intelligent roaming method according to claim 1 further comprising the steps of:
determining that the mobile station is not programmed for full service priority responsive to the steps of determining that the current communication system is not serviced by the home service provider and the preferred service provider; and
selecting the current communication system as a neutral service provider responsive to the step of determining that the mobile station is not programmed for full service priority to permit the mobile station to obtain limited service from the current communication system.

6. The intelligent roaming method according to claim 1 wherein the step of identifying the current communication system further comprising the steps of:
scanning a frequency band;
locating a control channel responsive to the step of scanning; and
receiving system information of the current communication system responsive to the step of locating the control channel.

7. The intelligent roaming method according to claim 1 wherein the step of determining that the current communication system is not serviced by a home service provider further comprising the steps of:
comparing system information of the current communication system to system information of the home service provider stored in the SAL; and
determining that the system information of the current communication system does not match the system information of the home service provider stored in the SAL responsive to the step of comparing.

8. The intelligent roaming method according to claim 1 wherein the step of determining that the current communication system is not serviced by a preferred service provider further comprising the steps of:
comparing system information of the current communication system to system information of preferred service providers stored in the SAL; and
determining that the system information of the current communication system does not match the system information of the preferred service providers stored in the SAL responsive to the step of comparing.

9. The intelligent roaming method according to claim 1 wherein the step of determining that the frequency band of the current communication system corresponds to the predetermined frequency band of frequency bands listed in the SAL further comprising the steps of:
comparing the frequency band of the current communication system to the frequency bands listed in the SAL; and
determining that the frequency band of the current communication system corresponds to the predetermined frequency band of frequency bands listed in the SAL responsive to the step of comparing.

10. An intelligent roaming method for enabling a mobile station to select a preferred neutral service provider from a plurality of service providers within a communication system, the method comprising the steps of:
scanning a frequency band;
locating a control channel responsive to the step of scanning;
receiving system information of the current communication system servicing a geographic area where the mobile station is presently located responsive to the step of locating the control channel to identify the current communication system;
comparing the system information of the current communication system to system information of a home service provider stored in a system access list (SAL) stored in the mobile station responsive to the step of receiving the system information of the current communication system;
determining that the system information of the current communication system does not match the system information of the home service provider stored in the SAL responsive to the step of comparing the system information of the current communication system to the system information of the home service provider to determine that the current communication system is not service by the home service provider;
comparing the system information of the current communication system to system information of preferred service providers stored in the SAL responsive to the step of receiving the system information of the current communication system;
determining that the system information of the current communication system does not match the system information of the preferred service providers stored in the SAL responsive to the step of comparing the system information of the current communication system to the system information of preferred service providers stored in the SAL to determine that the current communication system is not serviced by a preferred service provider;
comparing the frequency band of the current communication system to frequency bands listed in the SAL responsive to the steps of determining that the system information of the current communication system does not match the system information of the home service provider and the preferred service providers stored in the SAL;
determining that the frequency band of the current communication system corresponds to a predetermined frequency band of the frequency bands listed in the SAL responsive to the step of comparing the frequency band of the current communication system to the frequency bands listed in the SAL; and
selecting the current communication system as the preferred neutral service provider only when the frequency band of the current communication system corresponds to predetermined frequency band of the frequency bands listed in the SAL to permit the mobile station to obtain full service from the current communication system.

11. The intelligent roaming method according to claim 10 wherein the predetermined frequency band further comprises a first frequency band of the frequency bands listed in priority order in the SAL.

12. The intelligent roaming method according to claim 10 further comprising the steps of:
determining that the frequency band of the current communication system does not correspond to the predetermined frequency band of the frequency bands listed in the SAL responsive to the step of comparing the frequency band of the current communication system to the frequency bands listed in the SAL; and
selecting the current communication system as a foreign service provider responsive to the step of determining that the frequency band of the current communication system does not correspond to the predetermined frequency band of the frequency bands listed in the SAL to permit the mobile station to obtain emergency service from the current communication system.

13. The intelligent roaming method according to claim 10 further comprising the step of:
determining that the mobile station is programmed for full service priority responsive to the steps of determining that the system information of the current communication system does not match the system information of the home service provider and the preferred service providers stored in the SAL,
wherein the mobile station selects the current communication system as the preferred neutral service provider responsive to the step of determining that the mobile station is programmed for full service priority.

14. The intelligent roaming method according to claim 10 further comprising the steps of:
determining that the mobile station is not programmed for full service priority responsive to the steps of determining that the system information of the current communication system does not match the system information of the home service provider and the preferred service providers stored in the SAL; and
selecting the current communication system as a neutral service provider responsive to the step of determining that the mobile station is not programmed for full service priority to permit the mobile station to obtain limited service from the current communication system.

15. An intelligent roaming method for enabling a mobile station to select a preferred neutral service provider from a plurality of service providers within a communication system, the method comprising the steps of:
identifying a current communication system servicing a geographic area where the mobile station is presently located;
determining that the current communication system is not serviced by a home service provider responsive to the step of identifying the current communication system;
determining that the current communication system is not serviced by a preferred service provider responsive to the step of identifying the current communication system;
determining that the mobile station is programmed for full service priority responsive to the steps of determining that the current communication system is not serviced by the home service provider and the preferred service provider;
determining that a frequency band of the current communication system corresponds to a predetermined frequency band of frequency bands listed in a system access list (SAL) stored in the mobile station responsive to the step of determining that the mobile station is programmed for full service priority; and
selecting the current communication system as the preferred neutral service provider only when the frequency band of the current communication system corresponds to the predetermined frequency band of the frequency bands listed in the SAL to permit the mobile station to obtain full service from the current communication system.

16. The intelligent roaming method according to claim 15 wherein the predetermined frequency band further comprises a first frequency band of the frequency bands listed in priority order in the SAL.

17. The intelligent roaming method according to claim 15 further comprising the steps of:
determining that a frequency band of the current communication system does not correspond to the predetermined frequency band of the frequency bands listed in the SAL stored in the mobile station responsive to the step of determining that the mobile station is programmed for full service priority; and
selecting the current communication system as a foreign service provider responsive to the step of determining that the frequency band of the current communication system does not correspond to the predetermined frequency band of the frequency bands listed in the SAL to permit the mobile station to obtain emergency service from the current communication system.

18. The intelligent roaming method according to claim 15 further comprising the steps of:
determining that the mobile station is not programmed for full service priority responsive to the step of determining that the current communication system is not serviced by the preferred service provider; and
selecting the current communication system as a neutral service provider responsive to the step of determining that the mobile station is not programmed for full service priority to permit the mobile station to obtain limited service from the current communication system.

19. The intelligent roaming method according to claim 15 wherein the step of identifying the current communication system further comprising the steps of:
scanning a frequency band;
locating a control channel responsive to the step of scanning; and
receiving system information of the current communication system responsive to the step of locating the control channel.

20. The intelligent roaming method according to claim 15 wherein the step of determining that the current communication system is not serviced by a home service provider further comprising the steps of:
comparing system information of the current communication system to system information of the home service provider stored in the SAL; and
determining that the system information of the current communication system does not match the system information of the home service provider stored in the SAL responsive to the step of comparing.

21. The intelligent roaming method according to claim 15 wherein the step of determining that the current communication system is not serviced by a preferred service provider further comprising the steps of:
comparing system information of the current communication system to system information of preferred service providers stored in the SAL; and
determining that the system information of the current communication system does not match the system information of the preferred service providers stored in the SAL responsive to the step of comparing.

22. The intelligent roaming method according to claim 15 wherein the step of determining that the frequency band of the current communication system corresponds to the predetermined frequency band listed in the SAL further comprising the steps of:
comparing the frequency band of the current communication system to frequency bands listed in priority order in the SAL; and
determining that the frequency band of the current communication system corresponds to the predetermined frequency band of the frequency bands listed in the SAL responsive to the step of comparing.

23. An article adapted to be carried by a mobile station, the article adapted to store an intelligent roaming method for performing steps for enabling the mobile station to select a preferred neutral service provider from a plurality of service providers within a communication system, the article comprising:
a computer-readable data storage medium;
means recorded on the computer-readable data storage medium for performing a step of identifying a current communication system servicing a geographic area where the mobile station is presently located;
means recorded on the computer-readable data storage medium for performing a step of determining that the current communication system is not serviced by a home service provider responsive to the step of identifying the current communication system;
means recorded on the computer-readable data storage medium for performing a step of determining that the current communication system is not serviced by a preferred service provider responsive to the step of identifying the current communication system; and
means recorded on the computer-readable data storage medium for performing a step of determining that a frequency band of the current communication system corresponds to a predetermined frequency band of frequency bands listed in a system access list (SAL) stored in the mobile station responsive to the steps of determining that the current communication system is not serviced by the home service provider and the preferred service provider; and
means recorded on the computer-readable data storage medium for performing a step of selecting the current communication system as the preferred neutral service provider only when the frequency band of the current communication system corresponds to the predetermined frequency band of frequency bands listed in the SAL to permit the mobile station to obtain full service from the current communication system.

24. A mobile station adapted to store an intelligent roaming method for performing steps for enabling the mobile station to select a preferred neutral service provider from a plurality of service providers within a communication system, the mobile station comprising:
an antenna;
a transceiver electrically coupled to the antenna;
a control system electrically coupled to the transceiver; and
a computer-readable data storage medium electrically coupled to the control system;
means recorded on the computer-readable data storage medium for performing a step of identifying a current communication system servicing a geographic area where the mobile station is presently located;
means recorded on the computer-readable data storage medium for performing a step of determining that the current communication system is not serviced by a home service provider responsive to the step of identifying the current communication system;
means recorded on the computer-readable data storage medium for performing a step of determining that the current communication system is not serviced by a preferred service provider responsive to the step of identifying the current communication system; and
means recorded on the computer-readable data storage medium for performing a step of determining that a frequency band of the current communication system corresponds to a predetermined frequency band of frequency bands listed in a system access list (SAL) stored in the mobile station responsive to the steps of determining that the current communication system is not serviced by the home service provider and the preferred service provider; and
means recorded on the computer-readable data storage medium for performing a step of selecting the current communication system as the preferred neutral service provider only when the frequency band of the current communication system corresponds to the predetermined frequency band of frequency bands listed in the SAL to permit the mobile station to obtain full service from the current communication system.
